(19) United States
(12) Patent Application Publication
(10) Pub. No.: US 2007/0165394 A1
(43) Pub. Date: Jul. 19, 2007

(54) OPTICAL SHEET AND BACKLIGHT MODULE USING THE SAME

(75) Inventor: SHAO-HAN CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,487

(22) Filed: Aug. 11, 2006

(30) Foreign Application Priority Data
Jan. 14, 2006 (CN) 200610032949.5

(51) Int. Cl. G09F 13/04

(52) U.S. Cl. 362/97

(57) ABSTRACT

An optical sheet (21) includes a main body (210). The main body has a light incident surface (211) and a light emitting surface (212) positioned opposite to the light incident surface. A number of first valleys (213) and second valleys (214) are formed on the light emitting surface, and the second valleys intersect with the first valleys.

### FIELD OF THE INVENTION

The present invention generally relates to optical sheets and backlight modules using the same.

### DISCUSSION OF THE RELATED ART

Most liquid crystal display (LCD) devices are passive devices in which images are displayed by controlling an amount of light inputted from an external light source. Thus, a separate light source (for example, backlight module) is generally employed for illuminating an LCD panel.

Referring to FIG. 1, a typical backlight module 10 is shown. The backlight module 10 includes a prism sheet 11, a first diffusion sheet 12, a second diffusion sheet 13, and a light source 15. The prism sheet 11 includes a light incident surface 111 and a light emitting surface 112 opposite to the light incident surface 111. A plurality of elongated V-shaped grooves (not labeled) extend out of the light emitting surface 112 regularly in a direction and parallel to each other. The prism sheet 11 is located between the first diffusion sheet 12 and the second diffusion sheet 13, with the light emitting surface 112 adjacent to the first diffusion sheet 12, and the light incident surface 111 adjacent to the second diffusion sheet 13. The light source 15 is located adjacent to the second diffusion sheet 13. When light rays from the light source 15 are emitted into the prism sheet 11 after being scattered from the second diffusion sheet 13, the light rays are refracted from the prism sheet 11 and emit into the first diffusion sheet 12. The light rays are scattered from the first diffusion sheet 12 and finally emitted into an LCD panel (not shown) disposed on the first diffusion sheet 12.

In order to improve optical uniformity, a diffusion plate 14 is provided. The diffusion plate 14 is located between the second diffusion sheet 13 and the light source 15. Referring to FIG. 2, the diffusion plate 14 includes a transparent main body 141 and a plurality of dispersion particles 142 dispersed in the main body 141. The dispersion particles 142 are configured for dispersing the light rays. When the light rays are emitted into the diffusion plate 14, the light rays are scattered by the dispersion particles 142 time after time, and improving optical uniformity.

However, the backlight module 10 is easy to generate Newton ring interference action because the V-shaped grooves extend out of the light emitting surface 112 regularly in a direction, thereby decreasing the optical uniformity.

Therefore, a new optical sheet and a backlight module using the same are desired in order to overcome the above-described shortcomings.

### SUMMARY

An optical sheet according to a preferred embodiment includes a main body. The main body has a light incident surface and a light emitting surface positioned opposite to the light incident surface. A number of first valleys and second valleys are formed on the light emitting surface, and the second valleys intersect with the first valleys.

A backlight module according to another preferred embodiment includes a light source and an optical sheet having a light incident surface. The light source is positioned adjacent to the light incident surface of the optical sheet. The same optical sheet described in the previous paragraph is employed in this embodiment.

Other novel features will become more apparent from the following detailed description when taken in conjunction with the accompanying drawings.

### BRIEF DESCRIPTION OF THE DRAWINGS

Many aspects of the optical sheet and the backlight module using the same can be better understood with reference to the following drawings. The components in the drawings are not necessarily drawn to scale, the emphasis instead being placed upon clearly illustrating the principles of the present optical sheet and the backlight module using the same. Moreover, in the drawings, like reference numerals designate corresponding parts throughout the several views.

FIG. 1 is a schematic view of a conventional backlight module including a diffusion plate;

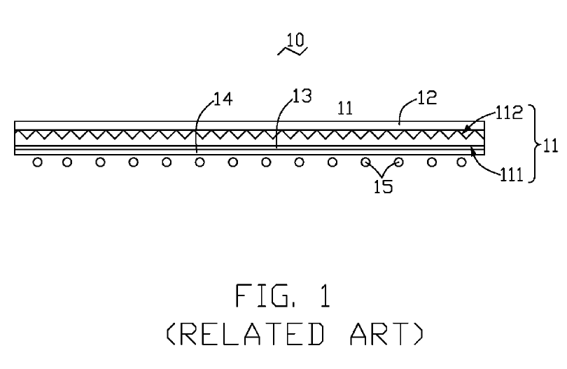

FIG. 2 is an enlarged, partially schematic view of the diffusion plate of FIG. 1;

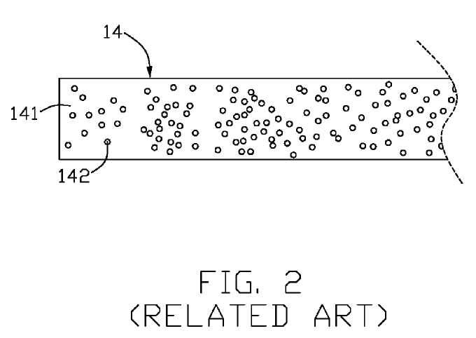

FIG. 3 is a schematic, isometric view of an optical sheet in accordance with a first embodiment;

FIG. 4 is a schematic, cross-sectional view taken along line IV-IV of FIG. 3;

FIG. 5 is an enlarged, cross-sectional, partially schematic view of a section of edges of each protrusion unit of the optical sheet being smoothed of FIG. 4;

FIG. 6 is similar to FIG. 5, but showing bottom edges of each protrusion unit of the optical sheet being smoothed of FIG. 4;

FIG. 7 is similar to FIG. 5, but showing all of the edges of each protrusion unit of the optical sheet being smoothed of FIG. 4;

FIG. 8 is a schematic, isometric view of an optical sheet in accordance with a second embodiment;

FIG. 9 is a schematic, isometric view of an optical sheet in accordance with a third embodiment;

FIG. 10 is a schematic, isometric view of an optical sheet in accordance with a fourth embodiment;

FIG. 11 is a schematic, isometric view of a backlight module in accordance with a first embodiment; and

FIG. 12 is a schematic, isometric view of a backlight module in accordance with a second embodiment.

### DETAILED DESCRIPTION OF THE EMBODIMENTS

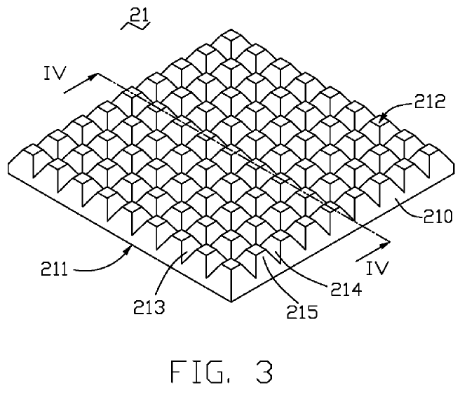

Referring to FIG. 3, an optical sheet 21 according to a first embodiment is shown. The optical sheet 21 includes a main body 210. The main body 210 includes a light incident surface 211, a light emitting surface 212 opposite to the light incident surface 211, and a first pair and a second pair opposite side surfaces (not labeled) between and adjoining the light incident surface 211 and the light emitting surface 212.

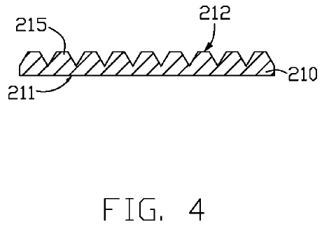

Referring also to FIG. 4, the main body 210 is substantially transparent and is made of plastic material. The light incident surface 211 is a flat surface. The light emitting surface 212 defines a plurality of first valleys 213 and second valleys 214. Each first valley 213 is substantially an elongated V-shaped groove. The first valleys 213 are spaced apart regularly, with each longitudinal side extending perpendicularly between the first pair of opposite side surfaces of the main body 210. Each two adjacent first valleys 213 substantially form a trapezoid-shaped protrusion. The second valleys 214 are similar to the first valleys 213. Each second valley 214 is substantially an elongated V-shaped groove that extends between the second pair of opposite side surfaces of the main body 210. The second valleys 214 are spaced apart regularly. Each two adjacent second valleys 214 substantially form a trapezoid-shaped protrusion. A depth of each second valley 214 is equal to that of each first valley 213. The second valleys 122 intersect with the first valleys 213 at right angles. The second valleys 214 and the first valleys 213 cooperatively form a plurality of frustum protrusion units 215, and the protrusion units 215 are formed on the light emitting surface 212 in a matrix manner.

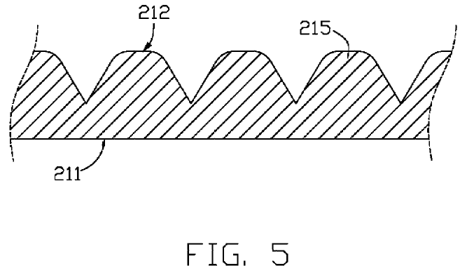

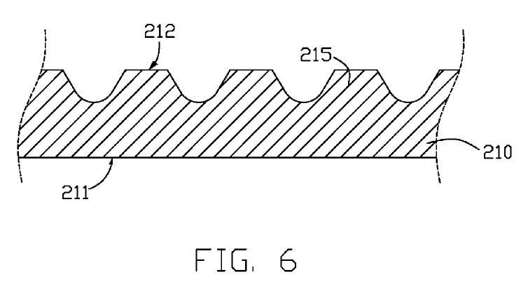

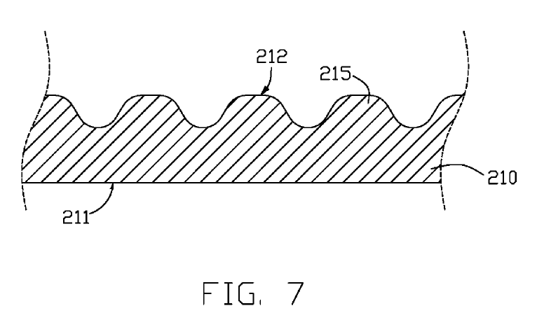

In order to limit a steep change of rate of optical illumination around edges of the protrusion units 215, a section of the edges of each protrusion unit 215 may be smoothed (shown in FIGS. 5 and 6), all of the edges of each protrusion unit 215 may also be smoothed (shown in FIG. 7).

In alternative embodiments, the first valleys 213 may be elongated trapezoid-shaped grooves, elongated arced-shaped grooves, elongated U-shaped grooves, a combination thereof or other suitable shapes. The first valleys 213 may be spaced apart irregularly. In alternative embodiments, the second valleys 214 may be elongated trapezoid-shaped grooves, elongated arced-shaped grooves, elongated U-shaped grooves, a combination thereof or other suitable shapes. The second valleys 214 may be spaced apart irregularly. In alternative embodiments, the second valleys 214 can intersect with the first valleys 213 at another angles.

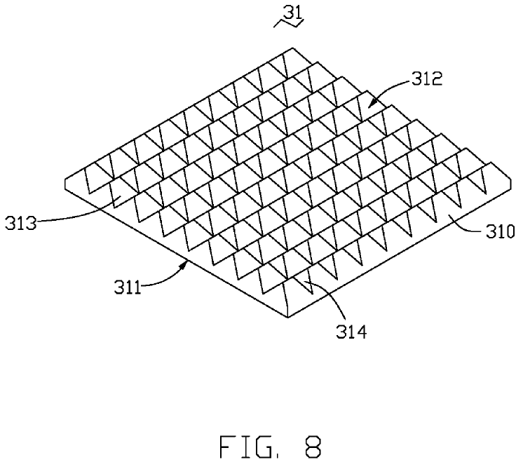

Referring to FIG. 8, an optical sheet 31 according to a second embodiment is shown. The optical sheet 31 includes a main body 310. The main body 310 includes a light incident surface 311, and a light emitting surface 312 opposite to the light incident surface 311. The light emitting surface 312 defines a plurality of first valleys 313 and second valleys 314. The optical sheet 31 is similar in principle to the optical sheet 21 described previously, except that the first valleys 313 are aligned side by side, and each two adjacent first valleys 313 substantially form a V-shaped protrusion where the adjacent first valleys 313 join each other.

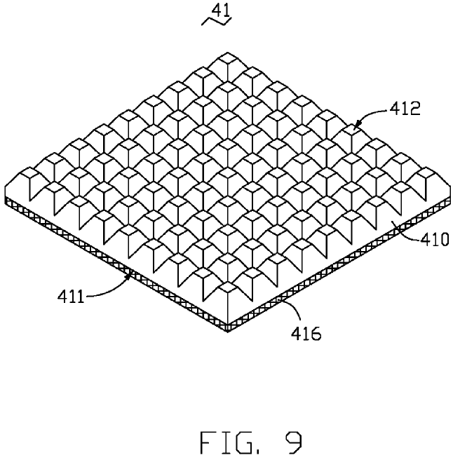

Referring to FIG. 9, an optical sheet 41 according to a third embodiment is shown. The optical sheet 41 includes a main body 410. The main body 410 includes a light incident surface 411, and a light emitting surface 412 opposite to the light incident surface 411. The optical sheet 41 is similar in principle to the optical sheet 21 described previously, except that a dispersion layer 416 is formed on the light incident surface 411. The dispersion layer 416 is configured for dispersing light rays. The dispersion layer 416 is obtained by applying a rough surface or by coating a dispersion material, for example ink.

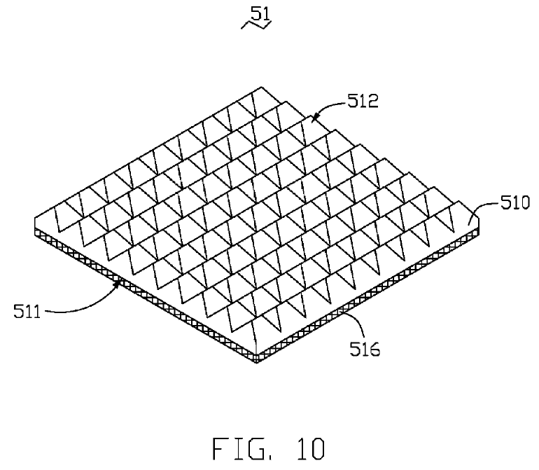

Referring to FIG. 10, an optical sheet 51 according to a fourth embodiment is shown. The optical sheet 51 includes a main body 510. The main body 510 includes a light incident surface 511, and a light emitting surface 512 opposite to the light incident surface 511. The optical sheet 51 is similar in principle to the optical sheet 31 described previously, except that a dispersion layer 516 is formed on the light incident surface 511. The dispersion layer 516 is configured for dispersing light rays. The dispersion layer 516 is obtained by applying a rough surface or by coating a dispersion material, for example ink.

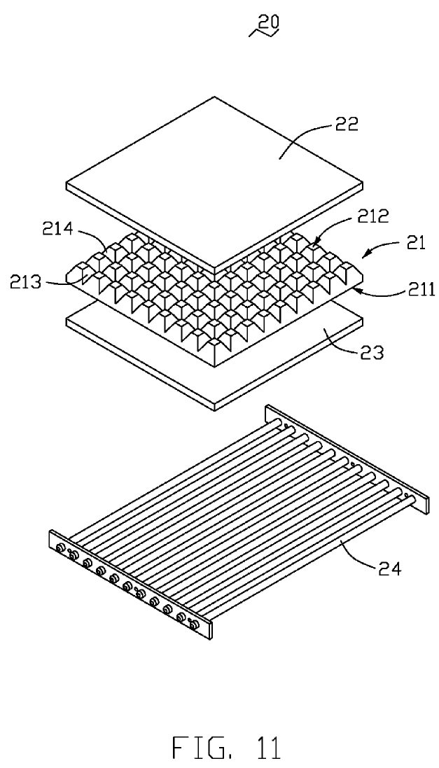

Referring to FIG. 11, a backlight module 20 according to a first embodiment is shown. The backlight module 20 includes a first diffusion sheet 22, an optical sheet 21, a second diffusion sheet 23, and a plurality of light sources 24 located in that order. The optical sheet 21 is described previously, and includes a main body 210. The main body 210 includes a light incident surface 211 and a light emitting surface 212 opposite to the light incident surface 211. The light emitting surface 212 defines a plurality of first valleys 213 and second valleys 214. The optical sheet 21 is located between the first diffusion sheet 22 and the second diffusion sheet 23, with the light emitting surface 212 adjacent to the first diffusion sheet 22, and the light incident surface 211 adjacent to the second diffusion sheet 23. The light sources 24 can be selected, for example, from one of cold cathode fluorescent lamps (CCFLs) and light emitting diodes (LEDs). In the illustrated embodiment, the light sources 24 employ CCFLs.

When the backlight module 20 is in use, light rays from the light sources 24 are projected towards the second diffusion sheet 23. The light rays are emitted into the optical sheet 21 after being scattered from the second diffusion sheet 23. The light rays are refracted at the optical sheet 21 before emitted into the first diffusion sheet 22. The light rays are scattered from the first diffusion sheet 23 and finally emitted into an LCD panel (not shown).

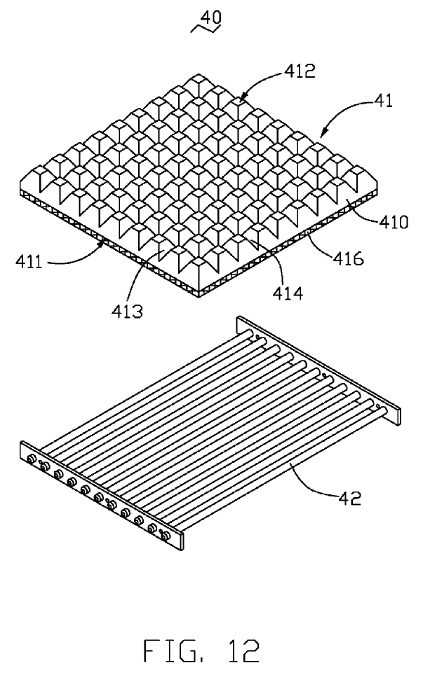

Referring to FIG. 12, a backlight module 40 according to a second embodiment is shown. The backlight module 40 includes an optical sheet 41 and a plurality of light sources 42. The optical sheet 41 is described previously, and includes a main body 410. The main body 410 includes a light incident surface 411 and a light emitting surface 412 opposite to the light incident surface 411. The light incident surface 411 disposes a dispersion layer 416. The light emitting surface 412 defines a plurality of first valleys 413 and second valleys 414. The light sources 42 are located adjacent to the light incident surface 411 of the optical sheet 41. The light sources 42 can be selected, for example, from one of cold cathode fluorescent lamps (CCFLs) and light emitting diodes (LEDs). In the illustrated embodiment, the light sources 42 employ CCFLs. When the backlight module 40 is in use, light rays from the light sources 42 are projected towards the light incident surface 411 of the optical sheet 41. The light rays are scattered at the dispersion layer 416 and refracted at the first valleys 413 and second valleys 414 of the light emitting surface 412. The light rays are finally emitted into an LCD panel (not shown).

In the above-described backlight module 40, the first and second valleys 413 and 414 intersect and locate on the light emitting surface 412 of the optical sheet 41. The backlight module 40 is difficult to generate Newton ring interference action, and to improve optical uniformity. In addition, the dispersion layer 416 locates on the light incident surface 411 of the optical sheet 41. In one hand, the light rays projected towards the optical sheet 41 are scattered by the dispersion layer 416, and to improve optical uniformity. In the other hand, the optical sheet 21 may replace a diffusion sheet and a prism sheet. Therefore, decreasing transmission loss of the light rays in the backlight module 40, and increasing brightness of the emitted light rays of the backlight module 40.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical sheet, comprising:
a main body including:
a light incident surface;
a light emitting surface positioned opposite to the light incident surface; and
a plurality of first valleys and second valleys formed on the light emitting surface, and the second valleys intersecting with the first valleys.

2. The optical sheet as claimed in claim 1, wherein the main body further includes a first pair and a second pair opposite side surfaces between and adjoining the light incident surface and the light emitting surface.

3. The optical sheet as claimed in claim 2, wherein the first valleys are spaced apart regularly, with each longitudinal side extending perpendicularly between the first pair of opposite side surfaces of the main body.

4. The optical sheet as claimed in claim 2, wherein the first valleys are aligned side by side, with each longitudinal side extending perpendicularly between the first pair of opposite side surfaces of the main body.

5. The optical sheet as claimed in claim 2, wherein the second valleys are spaced apart regularly, with each longitudinal side extending perpendicularly between the second pair of opposite side surfaces of the main body.

6. The optical sheet as claimed in claim 1, wherein the first valleys are selected from a group consisting of V-shaped grooves, trapezoid-shaped grooves, arced-shaped grooves, U-shaped grooves and a combination thereof.

7. The optical sheet as claimed in claim 1, wherein the second valleys are selected from a group consisting of V-shaped grooves, trapezoid-shaped grooves, arced-shaped grooves, U-shaped grooves and a combination thereof.

8. The optical sheet as claimed in claim 1, wherein a depth of each second valley is equal to that of each first valley.

9. The optical sheet as claimed in claim 1, wherein the second valleys intersect with the first valleys at right angles.

10. The optical sheet as claimed in claim 1, wherein the second valleys and the first valleys cooperatively form a plurality of protrusion units in a matrix manner, and at least a section of edges of each protrusion unit is smoothed.

11. The optical sheet as claimed in claim 1, further comprising a dispersion layer configured for dispersing light rays formed on the light incident surface.

12. The optical sheet as claimed in claim 1, wherein the main body is transparent, and is made of plastic material.

13. A backlight module, comprising:
a light source; and
an optical sheet, the optical sheet including:
a main body having:
a light incident surface, the light source being positioned adjacent to the light incident surface;
a light emitting surface positioned opposite to the light incident surface; and
a plurality of first valleys and second valleys formed on the light emitting surface, and the second valleys intersecting with the first valleys.

14. The backlight module as claimed in claim 13, wherein the main body further includes a first pair and a second pair opposite side surfaces between and adjoining the light incident surface and the light emitting surface.

15. The backlight module as claimed in claim 14, wherein the first valleys are spaced apart regularly, with each longitudinal side extending perpendicularly between the first pair of opposite side surfaces of the main body.

16. The backlight module as claimed in claim 14, wherein the first valleys are aligned side by side, with each longitudinal side extending perpendicularly between the first pair of opposite side surfaces of the main body.

17. The backlight module as claimed in claim 14, wherein the second valleys are spaced apart regularly, with each longitudinal side extending perpendicularly between the second pair of opposite side surfaces of the main body.

18. The backlight module as claimed in claim 13, further comprising a first diffusion sheet adjacent to the light emitting surface of the optical sheet, and a second diffusion sheet adjacent to the light incident surface of the optical sheet.

19. A light guide plate comprising:
a light incident surface;
a light emitting surface positioned opposite to the light incident surface, the light emitting surface being oriented substantially parallel to the light incident surface; and
an array of protrusions arranged on a whole area of the light emitting surface, each protrusion extending perpendicularly and outwardly from the light emitting surface, and having a cross section decreasing with increasing height from the light emitting surface toward a top of the each protrusion.

20. The light guide plate as claimed in claim 19, wherein the protrusions form smooth top edges.
